(19) United States
(12) Patent Application Publication
(10) Pub. No.: US 2025/0262678 A1
(43) Pub. Date: Aug. 21, 2025

(54) ANGLE ADJUSTABLE SAW

(71) Applicant: CHENG-FENG TSAI, Tainan City (TW)

(72) Inventor: CHENG-FENG TSAI, Tainan City (TW)

(21) Appl. No.: 18/444,764

(22) Filed: Feb. 19, 2024

(51) Int. Cl. B23D 49/11; B23D 51/01

(52) U.S. Cl. CPC B23D 49/11; B23D 51/01

(57) ABSTRACT

An angle adjustable saw includes a handle including a first cover body and a second cover body. One of two ends of the handle includes an opening. A space is formed in the handle and communicates with the opening, the first pivot hole and the adjustment hole. A blade includes a clamping portion inserted into the space of the handle through the opening, and being pivotably relative to the handle by a control assembly. Multiple protrusions are formed on a distal end of the clamping portion. Multiple recesses are formed between the protrusions. The control assembly includes an elastic button and a limiting component respectively connected to the first and second cover bodies of the handle. The limiting component has a block and is movable by pushing the elastic button to engage the block with one of the recesses of the clamping portion to set the blade at an angle.

### FIELD OF THE INVENTION

The present invention relates to a saw, and more particularly, to a saw with an angle adjustable saw blade.

### BACKGROUND OF THE INVENTION

Saws are commonly used for cutting wood, pipes, and metal materials. The saw blades cut through these objects by using the saw teeth on the blade. Sufficient space is required during the sawing process, and if there is limited space, the saw blade must be adjustable to different angles. Existing saw blades typically have only two angular positions, either unfolded or folded. As mentioned above, when cutting objects in various work environments, it is necessary to adapt to the spatial constraints. In many cutting tasks, it may be necessary to adjust the angle between the saw blade and the handle to enhance the efficiency of cutting. Although a few saw blades currently have the functionality of rotating to different angles, their assembly is often complex, and the production cost is high.

The present invention intends to provide an angle adjustable saw to eliminate the shortcomings mentioned above.

### SUMMARY OF THE INVENTION

The present invention relates to an angle adjustable saw and comprises a handle comprising a first cover body, a second cover body and a grip body, wherein the first cover body has a first fitting member, and the second cover body has a second fitting member into which the first fitting member is inserted. The grip body is enveloped on surfaces of the first cover body and the second cover body to form an integral structure. One of two ends of the handle includes an opening. Each of the first cover body and the second cover body has a first pivot hole and an adjustment hole. A space is formed in the handle and communicates with the opening, the first pivot hole and the adjustment hole. A blade includes a clamping portion which is inserted into the space of the handle through the opening. The clamping portion has a second pivot hole corresponding to the first pivot hole. Multiple protrusions are formed on a distal end of the clamping portion, and multiple recesses are formed between the protrusions. The blade has a first tooth portion and a second tooth portion formed on both sides thereof. A control assembly includes a pivot component, an elastic button, a limiting component and a connecting component. The pivot component passes through the first pivot holes and the second pivot hole to pivotably connect the blade which is pivotable and foldable relative to the opening of the handle. The elastic button and the limiting component are respectively connected to the adjustment holes of the handle. The connecting component connects the elastic button and the limiting component. The limiting component has a block extending radially therefrom so that the block is engaged with one of the recesses of the clamping portion to set the blade at an angle relative to the handle.

The primary object of the present invention is to provide a saw wherein the angle of the blade relative to the handle is achieved by pushing the elastic button of the control assembly to engage the block on the limiting component with one of the recesses of the blade.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the angle adjustable saw of the present invention;

FIG. 2 is another exploded view to show the angle adjustable saw of the present invention;

FIG. 3 is a perspective view to show the angle adjustable saw of the present invention;

FIG. 4 is an end cross sectional view, taken along line IV-IV in FIG. 3;

FIG. 5 is a cross sectional view of the angle adjustable saw of the present invention wherein the elastic button is pushed;

FIG. 6 is an end cross sectional view, taken along line VI-VI in FIG. 3;

FIG. 7 is a cross sectional view of the angle adjustable saw of the present invention wherein the blade is set at an angle relative to the handle;

FIG. 8 is a cross sectional view of the angle adjustable saw of the present invention wherein the blade is set at another angle relative to the handle, and

FIG. 9 is a perspective view to show another embodiment of the angle adjustable saw of the present invention.

### DETAILED DESCRIPTION OF THE PREFERRED EMBODIMENT

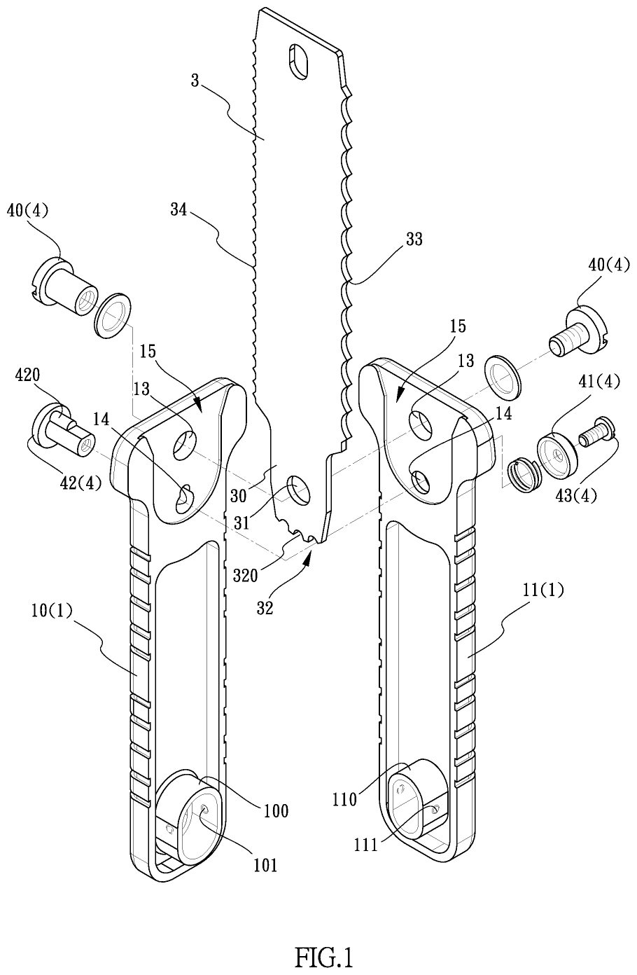

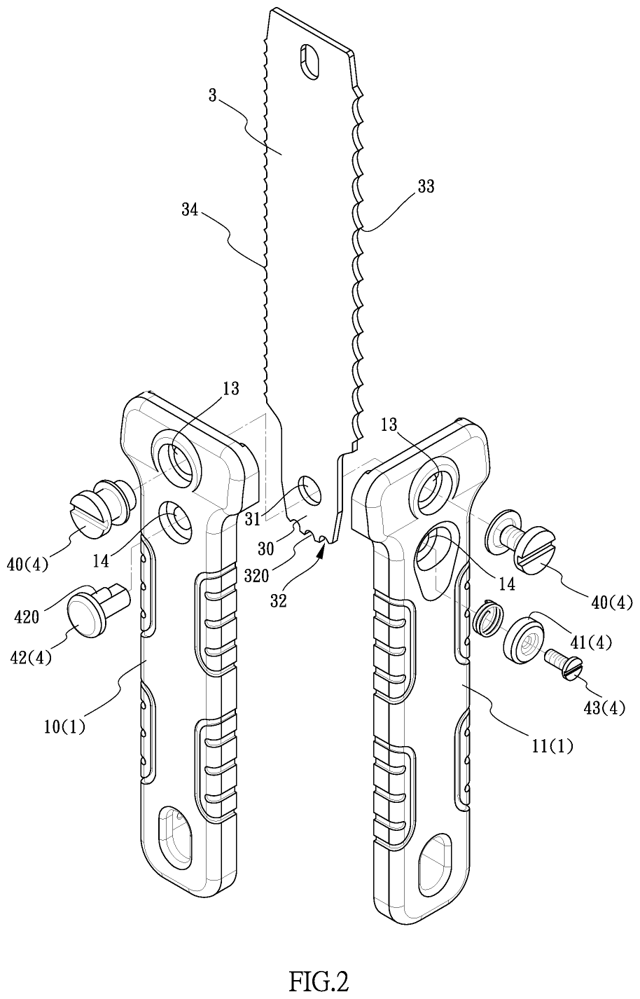

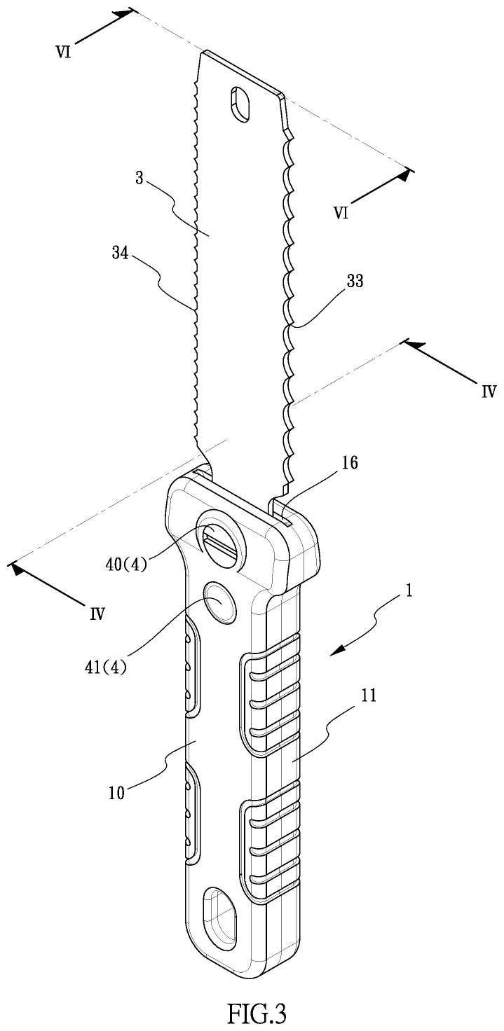

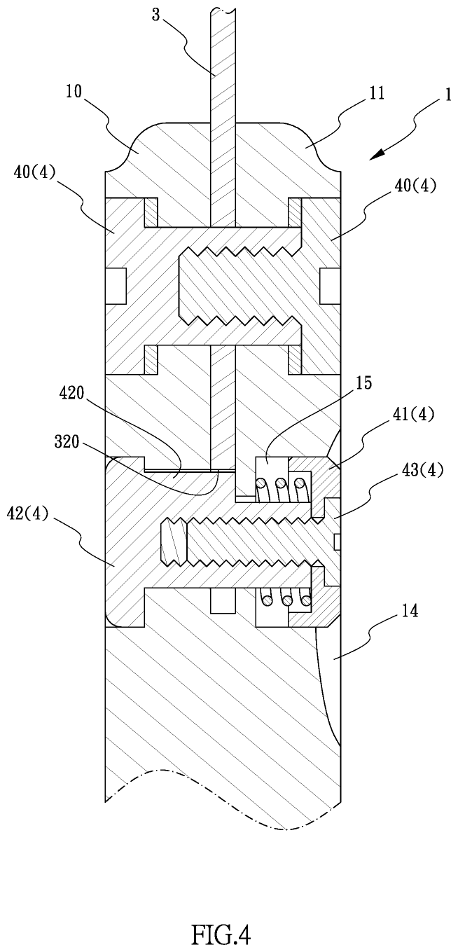

Referring to FIGS. 1 to 9, the angle adjustable saw of the present invention comprises a handle 1 comprising a first cover body 10, a second cover body 11 and a grip body 12. The first cover body 10 has a first fitting member 100, and the second cover body 11 has a second fitting member 110. The first fitting member 100 and the second fitting member 110 have corresponding positioning portions 101, 111.

One of two ends of the handle 1 includes an opening 16. Each of the first cover body 10 and the second cover body 11 includes a first pivot hole 13 and an adjustment hole 14 defined through therethrough. A space 15 is formed in the handle 1 and communicates with the opening 16, the first pivot hole 13 and the adjustment hole 14.

A blade 3 includes a clamping portion 30 which has a second pivot hole 31 corresponding to the first pivot hole 13. Multiple protrusions 32 are formed on a distal end of the clamping portion 30, and multiple recesses 320 are formed between the protrusions 32. The blade 3 has a first tooth portion 33 and a second tooth portion 34 formed on both sides thereof.

A control assembly 4 includes a pivot component 40, an elastic button 41, a limiting component 42 and a connecting component 43. The pivot component 40 passes through the first pivot holes 13 and the second pivot hole 31 to pivotably connect the blade 3 which is pivotable and foldable relative to the opening 16 of the handle 1. The elastic button 41 and the limiting component 42 are respectively connected to the adjustment holes 14 of the handle 1. The connecting component 43 connects the elastic button 41 and the limiting component 42. The limiting component 42 has a block 420 extending radially therefrom so that the block 420 is engaged with one of the recesses 320 of the clamping portion 30.

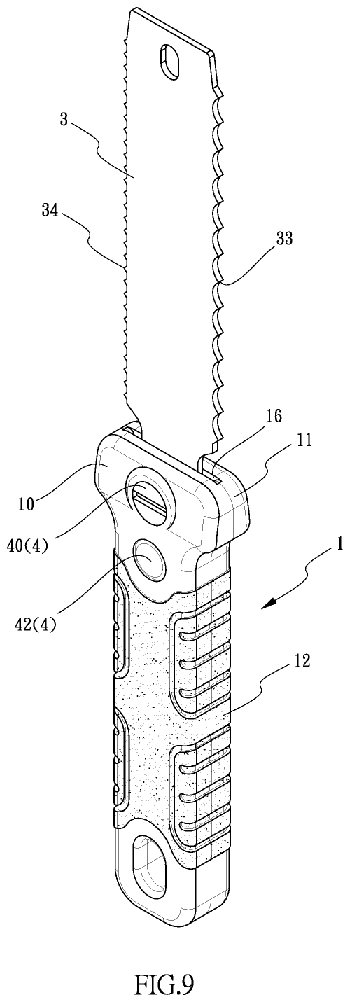

When assembling, the second fitting member 110 of the second cover body 11 is inserted into the first fitting member 100 of the first cover body 10, and the second fitting member 110 is connected to the first fitting member 100 by the engagement between the positioning portions 101, 111 as shown in FIG. 9. The grip body 12 is enveloped on surfaces of the first cover body 10 and the second cover body 11 to form an integral structure. The clamping portion 30 of the blade 3 is inserted into the space 15 of the handle 1 through the opening 16. The pivot component 40 in this embodiment includes a first part with a threaded portion, and a second part with a threaded hole. The first part and second part respectively pass through the first pivot holes 13 of the first and second cover bodies 10, 11, and the second pivot hole 31 to pivotably connect the blade 3 which is pivotable and foldable about the second pivot hole 31 within the opening 16 of the handle 1. The threaded portion of the first part of the pivot component 40 is threadedly connected to the threaded hole of the second part of the pivot component 40. The elastic button 41 and the limiting component 42 are respectively connected to the adjustment holes 14 of the handle 1. The connecting component 43 extends through the elastic button 41 and is connected to the limiting component 42 to connect the elastic button 41 and the limiting component 42. The block 420 is engaged with one of the recesses 320 of the clamping portion 30 to set the angle of the blade 3 relative to the handle 1.

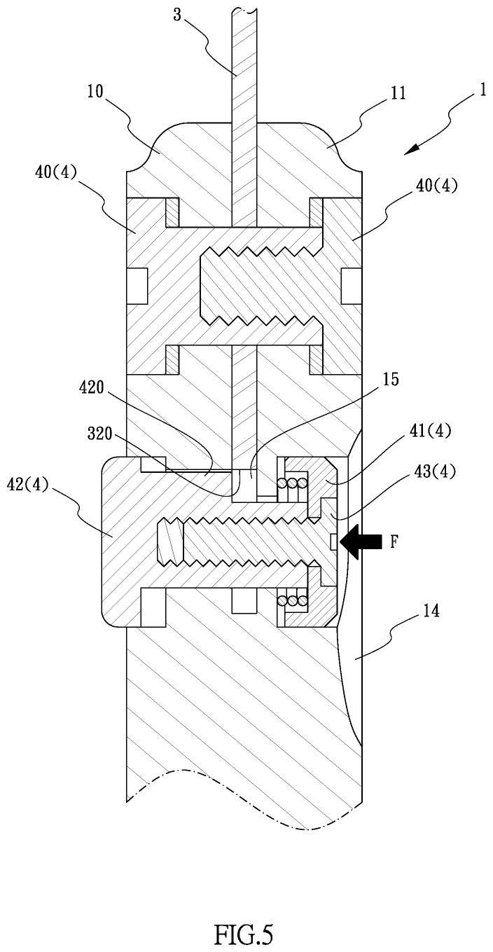

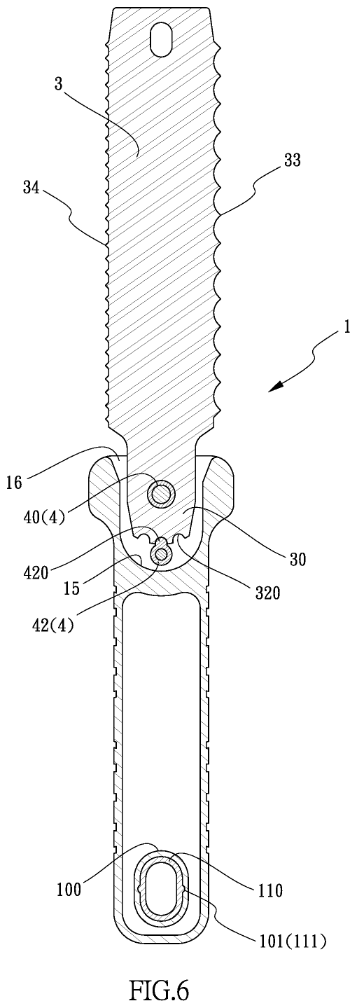

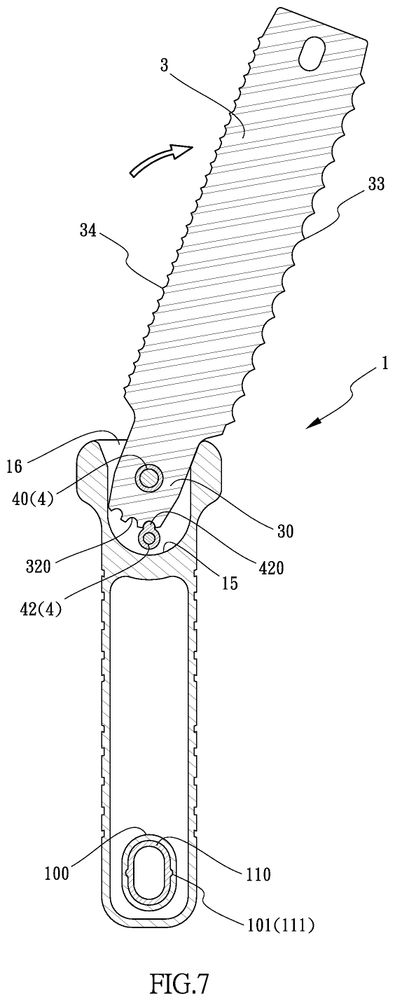

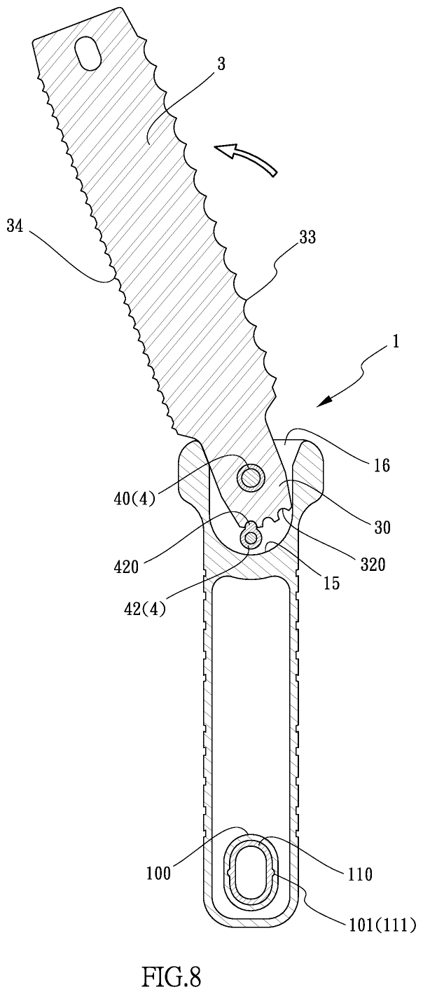

When adjusting the angle of the blade 3 relative to the handle 1, as shown in FIGS. 6 to 8, when pushing the elastic button 41 toward the handle 1 as shown in the arrow “F” in FIG. 5, the elastic button 41 compresses a spring and moves the limiting component 42 to remove the block 420 away from the recess 320, so that the blade 3 is pivotable within the opening 16. When releasing the elastic button 41, the spring brings the elastic button 41 and the limiting component 42 back to engage the block 420 with another recess 320 to set a new angle of the blade 3 relative to the handle 1 as shown in FIGS. 7 and 8. By the engagement between the block 420 and the recess 320, the blade 3 is set and does not pivot. The number of the recesses 320 can be varied to meet different requirements.

While we have shown and described the embodiment in accordance with the present invention, it should be clear to those skilled in the art that further embodiments may be made without departing from the scope of the present invention.

What is claimed is:

1. An angle adjustable saw comprising:
a handle (1) comprising a first cover body (10), a second cover body (11) and a grip body (12), the first cover body (10) having a first fitting member (100), the second cover body (11) having a second fitting member (110) into which the first fitting member (100) is inserted, the grip body (12) enveloped on surfaces of the first cover body (10) and the second cover body (11) to form an integral structure, one of two ends of the handle (1) including an opening (16), each of the first cover body (10) and the second cover body (11) including a first pivot hole (13) and an adjustment hole (14) defined through therethrough, a space (15) formed in the handle (1) and communicating with the opening (16), the first pivot hole (13) and the adjustment hole (14);
a blade (3) including a clamping portion (30) which is inserted into the space (15) of the handle (1) through the opening (16), the clamping portion (30) having a second pivot hole (31) corresponding to the first pivot hole (13), multiple protrusions (32) formed on a distal end of the clamping portion (30), multiple recesses (320) formed between the protrusions (32), the blade (3) having a first tooth portion (33) and a second tooth portion (34) formed on both sides thereof, and
a control assembly (4) including a pivot component (40), an elastic button (41), a limiting component (42) and a connecting component (43), the pivot component (40) passing through the first pivot hole (13) and the second pivot hole (31) to pivotably connect the blade (3) which is pivotable and foldable relative to the opening (16) of the handle (1), the elastic button (41) and the limiting component (42) respectively connected to the adjustment holes (14) of the handle (1), the connecting component (43) connecting the elastic button (41) and the limiting component (42), the limiting component (42) having a block (420) extending radially therefrom so that the block (420) is engaged with one of the recesses (320) of the clamping portion (30).

2. The angle adjustable saw as claimed in claim 1, wherein the first fitting member (100) and the second fitting member (110) have corresponding positioning portions (101, 111).
